(19) United States
(12) Patent Application Publication
(10) Pub. No.: US 2006/0068118 A1
(43) Pub. Date: Mar. 30, 2006

(54) Silicon-containing treatments for solid substrates

(76) Inventor: John A. Reeve, Midland, MI (US)

Correspondence Address: MCKELLAR IP LAW, PLLC, 784 SOUTH POSEYVILLE ROAD, MIDLAND, MI, 48640, US

(21) Appl. No.: 10/640,367

(22) Filed: Aug. 13, 2003

(51) Int. Cl. B05D 7/00; B05D 1/18

(52) U.S. Cl. 427/421.1; 427/430.1

(57) ABSTRACT

Treatments for solid substrates to enhance the durability thereof. The treatments are silicon-containing treatments that form silicon-containing networks on the substrate in a very rapid manner after the incipient components are applied to the solid substrate.

### BACKGROUND OF THE INVENTION

The invention disclosed and claimed herein deals with treatments for solid substrates to enhance the durability thereof. The treatments are silicon-containing treatments that are believed to form silicon-containing networks in a very rapid manner after the incipient components are applied to the solid substrate.

The treatments applied by the processes of this invention are durable immediately after application and are not removable from the substrate, as is demonstrated by power washing with water.

There are many patents and publications disclosing silanes, siloxanes, and other silicon-containing materials that are bondable to solid substrates. In addition, there are many such publications dealing with the use of the silanes, siloxanes and other silicon-containing materials to bond other materials to solid substrates, and such applications are old in the art.

For example, U.S. Pat. No. 5,051,129, that issued on Sep. 24, 1991 teaches that a wide variety of masonry products can be protected from the damaging effects of water penetration by the application of an aqueous solution containing a product obtained by combining water with an alkyltrialkoxysilane such as methyltrimethoxysilane and a water soluble silane coupling agent such as N-(2-aminoethyl)-3-aminopropyltrimethoxy silane.

Further, Narula, et al. in U.S. Pat. No. 5,205,860 that issued on Apr. 27, 1993 shows the use of surface treating compositions for preventing water penetration. The material described therein consists of combining water, an alkyltrialkoxysilane selected from the group consisting of C₁ to C₆ alkyl groups on silicon and blends of alkyltri alkoxysilanes with C₁ to C₆ alkyl groups on silicon; a silane coupling agent; and an aqueous silicone emulsion of an anionically stabilized hydroxyl end-blocked polydiorganosiloxane, amorphous silica and an organic tin salt, the tin salt ostensibly used as a catalyst for the system.

Roth, et al., in U.S. Pat. No. 5,250,106 that issued on Oct. 5, 1993, teaches a process for rendering masonry water repellent. The masonry is treated with a combination that is an organoalkoxysilane and/or an organosiloxane containing alkoxy groups and a water-soluble organic or inorganic acid salt of an organopolysiloxane.

Rich, et al., in U.S. Pat. No. 5,527,931 that issued on Jun. 18, 1996 teaches aqueous dispersible oil and water repellent silane masonry penetrants. The essence of the invention is the use of silanes compounds comprising hydrophilic, hydrophobic, and oleophobic, components which can effectively repel both water and oil based challenges.

In an example of bonding functionalized substances to solid substrates using silane chemistry, attention is directed to U.S. Pat. No. 6,258,454 that issued Jul. 10, 2001 to Lefkowitz, et al. in which low surface energy functionalized surfaces on solid supports are provided by treating a solid support having hydrophilic moieties on the surface, with a derivatizing composition containing a mixture of silanes. The resulting products are useful in chemistry and biotechnology such as solid phase chemical synthesis, wherein initial derivatization of a substrate surface enables synthesis of polymers such as oligonucleotides and peptides on the substrate itself.

It is also known in the prior art to treat solid substrates to create antimicrobial surfaces on them. Such processes are, for example, the treatment of fibers and fabrics. Common in the art is to treat such fibers and fabrics with silicones that have antimicrobial activity associated with them. U.S. Pat. No. 5,562,761, issued to Dirschl, et al., on Oct. 8, 1996 discloses the treatment of sheet materials made of fibrous materials, with aqueous dispersions that contain dihydroxypolyorganosiloxanes, amino functional silanes and cyclic oligosiloxanes and/or reaction products of these materials. It should be noted that the amino functional silanes that are described therein have the general formula YX₂Si(CHZ)ₚNH(CHZ)_{w}NH)_{q}H, that are primary and secondary amino functional silanes. Also described in the prior art is the use of quaternary ammonium alkoxysilanes which are taught in a wide variety of U.S. patents, namely, U.S. Pat. No. 3,560,385 that issued to Roth on Feb. 2, 1971; U.S. Pat. No. 3,794,736, that issued on Feb. 25, 1974 to Abbott, et al; U.S. Pat. No. 3,814,739, that issued to Takeda on Jun. 4, 1974. Additionally, the U.S. patents that teach that these compounds possess certain antimicrobial properties which make them valuable and very useful for a variety of surfaces, substrates, instruments, applications, and the like, are U.S. Pat. No. 3,730,701, that issued to Isquith, et al. on May 1, 1973; U.S. Pat. No. 3,794,736 noted supra; U.S. Pat. No. 3,860,709, that issued to Abbott, et al. on Jan. 14, 1975; U.S. Pat. No. 4,282,366, that issued to Eudy on Aug. 4, 1981; U.S. Pat. No. 4,408,996, that issued to Baldwin on Oct. 11, 1983; U.S. Pat. No. 4,414,268, that issued to Baldwin on Nov. 8, 1983; U.S. Pat. No. 4,504,541, that issued to Yasuda on Mar. 12, 1985; U.S. Pat. No. 4,615,937, that issued to Bouchette on Oct. 7, 1986, and U.S. Pat. No. 4,692,374, that issued to Bouchette on Sep. 8, 1987.

None of these prior art references show the processes of the instant invention to enhance the durability of the treatments on solid substrates, and moreover, none of these references teach or suggest that the effect of the treatment can be enhanced by such processes, for example, the enhanced antimicrobial effect of those materials having antimicrobial properties. The prior art does not show essentially instantaneous reactions to achieve water repellency and/or antimicrobial properties when applied at ambient conditions of 25° C. and that are that are stable to immediate rinsing with copious quantities of water thereafter.

### BRIEF SUMMARY OF THE INVENTION

One embodiment of this invention is a method of treating a solid substrate wherein the method comprises providing a solid substrate and spraying the solid substrate with an aqueous solution of a at least one material capable of reacting at or near the solid substrate surface selected from a group consisting of reactive silanes, reactive siloxanes, hydrolysis products of the above mentioned materials, and combinations of these materials.

Essentially, immediately thereafter, in a second step, the solid substrate from the first step is sprayed with a silicon-containing material capable of reacting at or near the solid substrate surface wherein such a material is selected from the group consisting of materials containing multi-silanol groups, siliconates, silicates, and, combinations of any of the materials containing multi-silanol groups, siliconates, and silicates (sometimes referred-to herein as “treatment enhancers”). What is meant by “essentially, immediately” is a time frame of up to within ½ hour of the application, but preferably within seconds of the first spray, and most preferably, within milliseconds of the application of the first spray.

There is also a second embodiment that is a method of treating a solid substrate wherein the method comprises providing a solid substrate and immersing the solid substrate in an aqueous solution of at least one material capable of reacting at or near the solid substrate surface selected from a group consisting of reactive silanes, reactive siloxanes, hydrolysis products of the reactive silanes and reactive siloxanes and, combinations of reactive silanes, reactive siloxanes, and hydrolysis products of the reactive silanes and reactive siloxanes.

Essentially, immediately thereafter, in a second step, the solid substrate from (II) is immersed in a silicon-containing material capable of reacting at or near the solid substrate surface selected from the group consisting of materials containing multi-silanol groups, siliconates, silicates, and, combinations of materials containing multi-silanol groups, siliconates, and silicates.

There is yet another embodiment of this invention that is a method of treating a solid substrate wherein the method comprises providing a solid substrate and spraying the solid substrate with an aqueous solution of at least one material capable of reacting at or near the solid substrate surface selected from a group consisting of reactive silanes, reactive siloxanes, hydrolysis products of the reactive silanes and reactive siloxanes and, combinations of the above materials, while essentially, simultaneously spraying the solid substrate with a silicon-containing material capable of reacting at or near the solid substrate surface selected from the group consisting of materials containing multi-silanol groups, siliconates, silicates, and, combinations of materials containing multi-silanol groups, siliconates, and silicates.

Yet another embodiment of the invention is the use of dianion containing materials in the aqueous solution that is first sprayed on the solid substrate or into which the solid substrate is first immersed, according to the processes of this invention.

### DETAILED DESCRIPTION OF THE INVENTION

In more detail, the invention deals with processes for enhancing the durability of treatments using certain materials to treat the surfaces of the solid substrate.

For purposes of this invention, any solid substrate may be treated to obtain the intended effect. For example, substrates such as fibers, woven and nonwoven fabrics, such as cotton, polyesters, nylon, rayon, acrylics, polyurethanes, polypropylenes and polyethylenes may be treated to obtain this effect. In addition, substrates that are not fibers and fabrics may be treated by the methods of this invention, for example, coatings, cast or molded sheets or articles of polyesters, nylon, rayon, acrylic, polyurethane, polypropylene and polyethylene may be effectively treated by the methods of this invention. In addition, paper and paper products, such as cardboard, wood, composite wood products, and other hard surfaces may be treated by the methods of this invention, as well as mineral surfaces such as stone, concrete, rock, and other mineral surfaces, and the like, polymer based siding, sheet rock, ceiling tile, flooring products, counter top materials, cabinets and veneer laminates, and other home and commercial construction products, and organic surfaces such as tar, asphalt and the like. Preferred solid substrates are mineral surfaces and especially preferred are roofing shingles that have mineral particles adhered to them, structural concrete, concrete block, bricks, and wood.

“Spraying” for purposes of this invention includes conventional spraying, as well as misting, fogging, and other methods that will provide minute particles and/or aerosols.

Essentially, the processes of this invention are novel by virtue of the mode in which the materials are applied to the solid substrate. For example, the method of treating a solid substrate, wherein the substrate is treated with an aqueous solution by spraying the solid substrate with an aqueous solution of the material capable of reacting at or near the solid substrate surface from the first group is described herein infra. This can be carried out by conventional spraying methods. After the application of this first group material, the treated substrate is subjected to the silicon-containing material capable of reacting at or near the solid substrate surface comprising the second group.

In some processes of end use application, it may be permitted to allow the material from the first group spraying dry before the material from the second group is applied. However, the preferred method for continuous application of the materials is to spray or dip the second group material immediately after the application of the first group material. For purposes of this invention, the application of the second group materials can be applied up to ½ hour after the application of the first material, but it is preferred that the application of the second material be applied within seconds of the application of the first material, and most preferred is the application of the second materials within milliseconds, for example, between 10 and 1000 milliseconds after the application of the first material.

Dipping for purposes of this invention means any conventional dipping process, roll application, brushing, padding, wiping or flooding, that will allow the solid substrate to be wetted by the materials being applied thereto.

As indicated above, the first group consists of (i) reactive silanes, (ii) reactive siloxanes, (iii) hydrolysis products of (i), (iv) hydrolysis products of (ii), and (v), combinations of any of (i), (ii), (iii), and (iv).

For purposes of this invention, useful reactive silanes (i) are those common silanes having hydrolyzable groups such as halosilanes, acetoxy silanes, alkoxy silanes, and oximo silanes. Further, other reactive silanes are those having amino groups, aldehyde groups and mercapto groups attached thereto.

Especially useful silanes of this invention, for example to provide water proofing to mineral surfaces, are alkoxysilanes, preferably trialkoxysilanes that are known in the art for such uses and most preferable is methyltrimethoxysilane. Also included, but not limiting the instant invention, are common water proofing materials such as, isobutytriethoxysilane, N-octyltriethoxysilane, and isooctyltrimethoxysilane.

Especially preferred as organofunctional silanes, are organofunctional silanes that have halo groups, acetoxy groups, alkoxy groups or oximo groups attached thereto and also contain organofunctional groups such as quaternary ammonium silicon-containing materials. Such quaternary ammonium silicon-containing materials can be selected from the group consisting of quaternary ammonium silanes, quaternary ammonium containing oligomer siloxanes, quaternary ammonium containing polymeric siloxanes, quaternary ammonium di- or tri-silanes, silanes or siloxanes having hydrocarbon linkages such as —Si(C) ySi—, wherein y has a value of 1 to 12, and quaternary ammonium containing siloxane/organic copolymers.

Examples of organofunctional silanes that are useful in this invention are those having the general formula (RO)ₙSi{(CₓH₂ₓ)N⁺(R²)_{b}(R³)_{3-b}X⁻}₄₋ₙ, wherein ₙ has a value of 1, 2, or 3; ₓ has a value of 1 to 20; R is hydrogen or an alkyl group having 1 to 6 carbon atoms; each R² is hydrogen or an alkyl group selected from the group consisting of 1 to 6 carbon atoms, X is a halogen, each R³ is hydrogen or an alkyl group selected from the group consisting of 1 to twenty carbon atoms and b has a value of 0, 1, 2, or 3.

Two silanes that are especially preferred for this invention are N,N-dimethyl-N-octadecyl-3-(trimethoxysilyl)propanaminium chloride and N,N-didecyl-N-methyl-3-(trimethoxysilyl)propanaminium chloride. Most preferred is the N,N-dimethyl-N-octadecyl-3-(trimethoxysilyl)propanaminium chloride.

An example of an oligomeric siloxane is

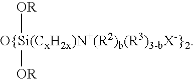

An example of a polymeric siloxane that is useful in this invention is 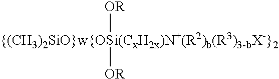
wherein w and x have a value of 1 or greater and b have a value of 0, 1, 2, or 3. Another example of such a polymeric siloxane is 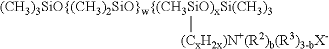
wherein the value of w is 1 or greater, and the value of x is from 1 to 12, it being understood that the reactive siloxanes (ii) of this invention have essentially the same functional groups as have been set forth for the reactive silanes Supra.

An example of a disilane of this invention is

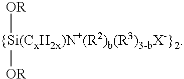

An example of a silicon-containing material that contains an —Si(C)ySi— bond is

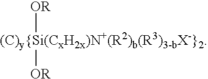

In this type of material, the value of y is on the order of about 1 to 4, and most preferably, it is 1 to 3.

A material that is useful in this invention that is a silicone/organic copolymer has the general formula 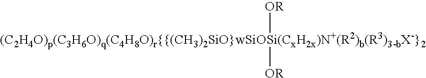
wherein the value of w is 1 to 10, the value of p, q, and r can each be from 0 to 25, and futrther provided that at least one of p, q or r has a value of at least one and the sum of p, q, and r does not exceed 25.

Especially useful silanes of this invention, for example to provide water proofing to mineral surfaces, are alkoxysilanes, preferably trialkoxysilanes that are known in the art for such uses and most preferably is methyltrimethoxysilane.

Hydrolysis products for purposes of this invention means any of the above materials that have been hydrolyzed using water or other compounds capable of converting the alkoxy groups to silanol groups on the silicon-containing materials. Sometimes, it is advantageous to carry out this hydrolysis using small amounts of catalyst, and sometimes, it is useful to “body” such materials, which is the common chemical application wherein the materials are catalyzed and then heated for a period of time with the subsequent removal of water as the byproduct. By removing the water that is formed by the condensation of the silanols, the material is caused to polymerize and increase in molecular weight, resulting in oligomeric materials as well as higher molecular weight materials.

In the second step of this process, the solid substrate after having been treated by the first material is subjected to a silicon-containing material capable of reacting at or near the solid substrate surface selected from a second group consisting of materials containing multi-silanol groups, siliconates, silicates, and, any combinations of multi-silanol groups, siliconates and silicates.

For purposes of this invention, materials containing multi-silanol groups that are anionic and are capable of forming reaction products with the hydrolyzed silanes are preferred. Silicates and siliconates represent such materials.

In this invention, what is meant by siliconates are those functional silicon materials that have an anion contained therein. Such materials are for example, potassium methyl siliconate having CAS No. 31795-24-1 which is an aqueous solution containing about 40 weight percent of the siliconate in water. In addition, lithium and sodium methyl siliconates can be used herein.

Also found useful in this invention are silicates, such as lithium, sodium and potassium silicates. These materials are commercially supplied in water at less than about 50 weight percent, and this makes them susceptible to spraying and dipping techniques.

As an adjunct to the reactive materials of the first group, there may be used compounds having dianions. Such materials are described in pending U.S. patent application Ser. No. 10/052,002, filed on Jan. 17, 2002 in the name of John Reeve, the teachings of which are incorporated herein by reference for what that reference teaches about the chemistry and uses of antimicrobial agents, and for what it teaches about the chemistry and make-up of the dianion materials.

Now, so that those skilled in the art can fully understand and appreciate the invention, the following examples are provided.

In the examples, sodium silicate is a 46.8%, 42° Baume Na₄SiO₄ purchased from the Chemistry Store, 520 NE 26 Ct., Pompano Beach, Fla. 33064. Polyoxyethylene Nonylphenol is CAS No. 84852-15-3 surfactant.

Sodium oxalate is CAS No. 62-76-0, purchased from Fisher Scientific. Everwood is a proprietary mixture of silicates and silanes at 6.58% solids, purchased from Evercrete Corporation, Las Vegas, Nev. 89119, and the potassium methyl siliconate is DC-777, a 40% aqueous solution purchased from Dow Corning Corporation, Midland, Mich.

The BPB test is a standardized test known as the Bromphenol Blue Extraction Method having a Dow Corning Corporate test number 0824, except that the test was modified in the following manner. The chlorinated solvent has been eliminated and the wavelength is 595 nm. Further, the Dow Corning® Q25211 has been substituted for the Triton RTM.X100 wetting agent of the test. What is measured is the diminution of the BPB absorbance at 595 nm relative to the BPB standard solution and it is reported in percent extraction. Antimicrobial efficacy was determined using the Dow Corning Test Method 0923 Dynamic Shake Flask Test (ASTM E-2149-01) unless otherwise stated.

Application was carried out by using a small pump mister and the amount of material was controlled by wet weight pickup of the samples after spraying. The treated samples were immediately rinsed in copious cold water to remove any excess materials and prevent further bonding to the surface.

### EXAMPLE 1

### Comparative Example

The antimicrobial agent used in this example was N,N-dimethyl-N-Octadecyl-3-(trimethoxysilyl)propanaminium chloride at 1% in water/methanol.

An aqueous solution of this agent was sprayed onto an asphalt roofing shingle at room temperature and then immediately rinsed in cold water without any heating or curing, and then tested for the presence of the antimicrobial agent using a BPB Direct Stain test.

The result was that the material washed off in the rinsing process and gave no BPB color on the shingle.

### EXAMPLE 2

In comparison, using the method of this invention, the experiment was repeated using a spray application of the antimicrobial agent followed immediately by the spray treatment of the treated substrate using potassium methyl siliconate. Immediately thereafter, without heating or curing, the solid substrate was rinsed with copious amounts of water and then tested as above. The test result showed that the antimicrobial material had adhered to the substrate and remained there after the copious water washing.

### EXAMPLE 3

Application technologies were compared for a shingle substrate at constant add levels and room temperature conditions. Samples were prepared as follows and compared. The Samples included: antimicrobial agent (AA) by itself (Sample 1) and the (AA) in 0.1M Na₂C₂O₄ (Sample 2) with a polyoxyethylene nonylphenol (the surfactant). Sample 1 treated with Methyl Siliconate is Sample 3, Sample 1 treated with sodium silicate is Sample 4 and sample 1 treated with Everwood is Sample 5. The Samples were handled as in example 1 and tested. The results are shown in TABLE 1.

TABLE I

| | | |
|---|---|---|
| | % BPB Extraction | % Reduction* |
| Application | AA Actives | AA Actives |

| Technology | 0.05% | 1% | 0.50% | 1% |
|---|---|---|---|---|
| Sample 1 | 3 | 8 | 0 | 0 |
| Sample 2 | 9 | 9 | 0 | 9 |
| Sample 3 | 16 | 16 | 10 | 0 |
| Sample 4 | 34 | 45 | 3 | 6 |

*% Reductions are calculated based on comparison to untreated controls and are low because the materials extracted from the asphalt of the shingles reduce the test microbes and yield an apparent antimicrobial response on their own.

### EXAMPLE 4

Studies were carried out to determine if this invention was applicable to various substrates in the building products area, such as Oriented Strand Board (OSB), vinyl siding, polymer wood composite decking and dimensional lumber. The application process was: samples were cut to 2 inches by 2 inches and weighed prior to application. A hand pump mist sprayer was used to treat the substrate. The applications of the silicate/siliconate and (AA) were kept to a minimum of less than 3 seconds application timne. Treated samples were next rinsed with copious cold water to remove any excess treatment material. There was no heating or other curing or drying of the samples.

Sample 1 was 0.5% (AA) only on OSB; Sample 2 was 0.5%(AA) and 0.1M Oxalate on OSB; Sample 3 was 0.5% (AA) only on southern yellow pine; Sample 4 was 0.5% (AA) and 0.1M Oxalate on Southern yellow pine; Sample 5 was 0.5% (AA) on vinyl siding; Sample 6 was 0.5% (AA) and 0.1M oxalate on vinyl siding; Sample 7 was 0.5% (AA) on composite decking and Sample 8 was 0.5% (AA) and 0.1M oxalate on composite decking. The results are shown in TABLE II for % BPB extraction and in TABLE III for E. Coli reduction values.

TABLE II

| | | | % BPB Extraction | | | | |
|---|---|---|---|---|---|---|---|
| | (AA) | Na₄SiO₄ | shingle | siding | decking | wood | |
| Application | Actives | Actives | % BPB | % BPB | % BPB | % BPB | OSB |
| Technology | mg/inch² | mg/inch² | ext. | ext. | ext. | ext. | % BPB ext. |
| Control | 0 | 0 | 0 | 0 | 0 | 0 | 0 |
| Sample 1 | 1.25 | 0.00 | 3 | 4 | 3 | 37 | 46 |
| Sample 2 | ″ | ″ | 9 | 9 | 10 | 62 | 46 |
| Sample 3 | ″ | 0.313 | 18 | 17 | 16 | 63 | 56 |
| Sample 4 | ″ | 0.625 | 34 | 12 | 19 | 82 | 65 |
| Sample 5 | ″ | 0.938 | 39 | 21 | 39 | 92 | 70 |
| Sample 6 | ″ | 1.250 | 77 | 17 | 37 | 92 | 70 |
| Sample 7 | ″ | 1.875 | 93 | 17 | 55 | 95 | 67 |
| Sample 8 | ″ | 2.500 | 68 | 20 | 57 | 95 | 70 |

TABLE III

| | | | % E. Coli Reduction | | | | |
|---|---|---|---|---|---|---|---|
| | (AA) | Na₄Si₄O₄ | shingle | siding | decking | wood | |
| Application | Actives | Actives | % Red. | % Red. | % Red. | % Red. | OSB |
| Technology | mg/inch² | mg/inch² | ext. | ext. | ext. | ext. | % Red. ext. |
| Sample 1 | 1.25 | 0.00 | 11 | 0 | 0 | 21 | 31 |
| Sample 2 | ″ | ″ | 13 | 3 | 8 | 30 | 28 |
| Sample 3 | ″ | 0.313 | 13 | 0 | 15 | 97 | 53 |
| Sample 4 | ″ | 0.625 | 2 | 0 | 22 | 60 | 48 |
| Sample 5 | ″ | 0.938 | 12 | 0 | 22 | 96 | 64 |
| Sample 6 | ″ | 1.250 | 10 | 6 | 6 | 99.6 | 41 |
| Sample 7 | ″ | 1.875 | 17 | 0 | 0 | 40 | 42 |
| Sample 8 | ″ | 2.500 | 20 | 2 | 5 | 57 | 60 |

* % Reductions are all based on untreated control substrates.

### EXAMPLE 5

Samples were provided in which the substrates were treated as in Example 4 above, except that a surfactant/wetting agent, polyoxyethylene nonylphenol, was used in conjunction with the sodium oxalate. The samples were tested in the % BPB extraction test and the results are shown in TABLE IV.

TABLE IV

| | | | % BPB Extraction | | | |
|---|---|---|---|---|---|---|
| | | | | | wood | OSB |
| | (AA) | | siding | decking | % | % |
| Application | Actives | Na₂C₂O₄ + | % BPB | % BPB | BPB | BPB |
| Technology | mg/inch² | NP 9 | ext. | ext. | ext. | ext. |
| Sample 1 | 1.25 | 0 | 4 | 3 | 37 | 36 |
| Sample 2 | ″ | 0.1M | 9 | 10 | 62 | 46 |

### EXAMPLE 6

This series of materials using Oriented Strand Board (OSB) were evaluated using a ladder series of sodium silicate or Na₄SiO₄ and AA using a spray application. The exact amount added in mg/square inch actives are shown in the following tables.

TABLE V

| Sample | mg/ft² | % BPB | % Reduction | mg/ft² |
|---|---|---|---|---|
| ID | AA Actives | Extraction | E. Coli | Na₄SiO₄ |
| A | 35 | 21 | 55 | 42.12 |
| B | 35 | 24 | 54 | 42.12 |
| C | 35 | 23 | 56 | 42.12 |
| D | 90 | 43 | 60 | 126.36 |
| E | 90 | 42 | 60 | 126.36 |
| F | 90 | 54 | 63 | 126.36 |
| G | 135 | 57 | 52 | 210.60 |
| H | 135 | 49 | 60 | 210.60 |
| I | 135 | 66 | 59 | 210.60 |

### EXAMPLE 7

Samples of ½ inch Oriented Strand Board (OSB) were cut into 2×2 inch squares for BPB and Direct Stain testing. The AEM 5772 was applied first using a small paint brush, and the Na₄SiO₄ brushed on immediately thereafter. The sample was then rinsed with copious water. Samples were allowed to air dry before testing. The concentration of actives for AA and sodium silicate are shown in TABLE VI

TABLE VI

| mg/ft² AEM Actives | mg/ft² Na₄SiO₄ Actives | Water Rinse |
|---|---|---|
| 135 | 90 | Yes |
| 135 | 180 | Yes |
| 135 | 270 | Yes |
| 0 | 0 | Yes |

The % BPB Extractions obtained for the samples are shown in the TABLE VII.

TABLE VII

| mg/ft² AEM Actives | mg/ft² Na₄SiO₄ Actives | % BPB Extraction |
|---|---|---|
| 135 | 90 | 54 |
| 135 | 180 | 49 |
| 135 | 270 | 62 |
| 0 | 0 | 0 |

### EXAMPLE 8

The effectiveness of the materials containing multi-silanol groups, siliconates, silicates, and any combinations of them (hereinafter sometimes referred-to as “treatment enhancer”, in causing reaction to occur was measured by the appearance of reaction product compared to the hydrolyzed silanes without the reaction product. This example also shows examples of various silanes that are effective in this invention.

Each of five commercial silanes were added to methanol and water solutions and allowed to hydrolyze from their alkoxy forms to the free silanol forms. After hydrolysis and activation, each of the silanes was mixed with treatment enhancers and the characteristics of the solutions were observed with time. For the silanes Z6341, 2306, and 6300, 1% by volume was prepared in a 50:50 mixture of methanol and water. Two milliliters of each silane and two milliliters of the treatment enhancer were combined. Each treatment enhancer was made up at 1.5% active ingredient. The formation of visible turbidity, turbidity and/or precipitate and gel were noted as evidence of the effectiveness of the treatment enhancer in causing a reaction to occur. The treatment enhancers alone, as well as the activated, were also observed for any evidence of reaction by change in the solution characteristics. All experimentation was carried out at ambient conditions and no heating was used to accelerate reactions.

The silanes used were as follows.

| | | | CAS | |
|---|---|---|---|---|
| Supplier | Silane | Name | Number | Wt. % |
| Dow Corning | Z-6341 | N-octyltriethoxysilane | 2943-75-1 | >60.0 |
| ″ | Z-2306 | i-butyltrimethoxysilane | 18395-30-7 | >60.0 |
| ″ | Z-6300 | vinyltrimethoxysilane | 2768-02-7 | >60.0 |
| ″ | Z-6403 | i-butyltriethoxysilane | 17980-47-1 | >60.0 |
| ″ | Z-6672 | i-octyltrimethoxysilane | 34396-03-7 | >60.0 |

The results can be found on TABLE VIII.

TABLE VIII

| | | Treatment | Time | | | |
|---|---|---|---|---|---|---|
| ID | Silane | enhancer | Min. | Appearance | Time hours | Appearance |
| A | Z-2306 | Everwood | 10 | turbid ppt | 20 | v. turbid ppt |
| B | Z-2306 | DC-777 | 26 | turbid ppt | 20 | v. turbid ppt |
| C | Z-2306 | Na₄SiO₄ | 8 | turbid ppt | 20 | v. turbid ppt |
| Control Silane | Z-2306 | None | 10 | clear | 20 | clear |
| D | Z-6341 | Everwood | 5 | sl. turbid ppt. | 20 | sl. turbid ppt |
| E | Z-6341 | DC-777 | 26 | sl. turbid ppt | 20 | turbid ppt |
| F | Z-6341 | Na₄SiO₄ | 7 | sl. turbid ppt | 20 | turbid ppt |
| Control Silane | Z-6341 | None | 10 | clear | 20 | clear |
| G | Z-6300 | Everwood | 7 | sl. turbid ppt | 20 | gel |
| H | Z-6300 | DC-777 | 20 | clear/sl. turbid | 0 | ppt |
| I | Z-6300 | Na₄SiO₄ | 7 | sl. turbid ppt | | gel |
| Control Silane | Z-6300 | None | 10 | clear | 20 | clear |
| J | Z-6403 | None | >1 | v. turbid ppt | 24 | gel/ppt |
| K | Z-6403 | DC-777 | >1 | v. turbid ppt | 24 | turbid/ppt |
| L | Z-6403 | Na₄SiO₄ | >1 | turbid gel | 24 | gel/ppt |
| Control Silane | Z-6043 | None | >1 | clear | 24 | clear |
| M | Z-6672 | Everwood | >1 | v. turbid gel | 24 | gel/ppt |
| N | Z-6672 | DC-777 | >1 | v. turbid | 24 | turbid/ppt |
| O | Z-6672 | Na₄SiO₄ | >1 | v. turbid gel | 24 | gel/ppt |
| Control Silane | Z-6672 | None | >1 | clear | 24 | clear |
| Control AA | None | Everwood | 10 | clear | 20 | clear |
| Control AA | None | DC-777 | 10 | clear | 20 | clear |
| Control AA | None | Na₄SiO₄ | 10 | clear | 20 | clear |

Sl. = slightly,
v. = very,
ppt = precipitate
In all cases, the hydrolyzed, activated silanes did not show any gelling or turbidity over extended periods of time.

The materials all showed activity with the activated silanes in the form of turbidity, precipitation and gelling which occurred in less than 30 minutes after adding the component. None of the treatment enhancers showed any reaction at their 1.5% active concentration at times of less than 24 hours. Only the potassium siliconate had a white precipitate after 4 days of standing at the 1.5% actives level.

### EXAMPLE 9

The material prepared for this example is N,N-dimethyl-N-Octadecyl-3-(trimethoxysilyl)propanaminium chloride, 0.1M Na₂C₂O₄ and with a nonionic surfactant at pH of 12. This first solution provides a clear and stable solution for spray application to the substrates.

The first material was applied to the substrate followed by a sodium silicate solution. The first material solution was applied at 1.25 gm/inch² while the sodium silicate was applied at 1.875 mg/inch².

A spray application of both solutions was used, and immediately after spraying the second solution on the room temperature substrate, the sample was washed with copious cold water and another sample was washed with copious cold water and cleaned with a brush followed immediately without drying, by analysis using % BPB extraction.

After calibration of the spray mister, 0.3 grams of each solution was applied to the ambient temperature substrate; first solution was applied, followed by a second 0.3 gram spray of the second solution.

Quat Salt is the use of the quaternary silane by itself. Sample 1 is the quaternary silane and the dianionic material, and Sample 2 is the application of the quaternary silane followed by the sodium silicate. The results are in Table IX.

TABLE IX

| | | | % BPB Extraction | | | | | | | |
|---|---|---|---|---|---|---|---|---|---|---|
| | First mtl. | Na₄SiO₄ | Decking | | Wood | | Shingle | | OSB | |
| Application | Actives | Actives | No | Decking | No | Wood | No | Shingle | No | OSB |
| Technology | mg/in² | mg/in² | Brush | Brush | Brush | Brush | Brush | Brush | Brush | Brush |
| Quat silane | 1.25 | 0.00 | 10 | 4 | 30 | 30 | 2 | 4 | 35 | 40 |
| Sample 1 | 1.25 | 0.00 | 14 | 13 | 47 | 36 | 5 | 12 | 32 | 35 |
| Sample 2 | 1.25 | 1.875 | 28 | 12 | 48 | 32 | 55 | 32 | 57 | 45 |
| S-1 + S 2 | 1.25 | 1.875 | 17 | 11 | 46 | 36 | 15 | 12 | 36 | 35 |
| Control | 0 | 0 | 0 | 0 | 0 | 0 | 0 | 0 | 0 | 0 |

Results
The Sample 2 technology using sodium silicate provided the highest % BPB extractions for all substrates whether brushed or not. Substrates absorbing the least liquid (shingles and decking) showed the greatest benefit of the Sample 2 technology. For highly absorbing substrates (OSB and Wood), all technologies demonstrated the ability to apply and hold the micropolymer network on the surface. Brushing the substrate after treatment and in the wet state generally caused a lowering of % BPB Extraction and showed loss of the some of the applied material for most samples.

### EXAMPLE 10

Use of tetraethylorthosilicate (TEOS)

Hydrolysis:

TEOS was hydrolyzed by making up a solution in water with a molar ratio of water R_{w} to TEOS of 5 to 100. A mineral acid such as HNO₃ or HCl was used to lower the pH to catalyze the hydrolysis reaction. The molar ratio Rₐ of acid to TEOS is typically 0.01 to 0.10. Under these conditions the hydrolysis is exothermic, and completes in less than 20 minutes at ambient temperature. Formation of extended gels will occur over a period of days to weeks if the active silanol groups are not protected from condensation reactions. A 10% solution of TEOS in deionized water was acidified with hydrochloric acid and stirred until the separated layer on the surface disappeared. The hydrolyzed TEOS was put into a spray mister for application to the substrates

Application:

Samples of shingles, composite decking boards and Oriented Strand Board (OSB) were cut into 2 inch squares for application. The spray mister was calibrated for weight of delivery, and 0.3 grams of each solution was sprayed onto the substrates. The level of N,N-dimethyl-N-Octadecyl-3-(trimethoxysilyl)propanaminium chloride was held constant at 1.25 mg/inch² and it was the first solution sprayed onto the samples. For the Sample 1 and Sample 1+Sample 2 applications, the Sample 1 solution was applied first, followed by the Sample 2 solution. All samples were at ambient temperature, and were rinsed immediately with copious, cold water. The % BPB Extraction was measured while the samples were wet to prevent the applied materials from drying and curing.

Results:

The samples represent a range of liquid absorption capacity with the shingle absorbing the least liquid, and the OSB absorbing the most. Both Sample 2 technologies gave the highest % BPB Extraction on the shingle sample, compared to N,N-dimethyl-N-Octadecyl-3-(trimethoxysilyl)propanaminium chloride alone or the Sample 1 technology. The formation of the micropolymer network depends entirely on the Sample 2 components completing the reaction in the wet state while minimal covalent bonds are formed with the shingle granules or asphalt base. The composite decking is composed of PVC and wood flour and has absorbance between the shingle and OSB. The Sample 2 technologies provide the greatest bonding compared to the N,N-dimethyl-N-Octadecyl-3-(trimethoxysilyl)propanaminium chloride (AEM) alone or Sample 1 alone. For the OSB samples, all of the application techniques show improved bonding. Only the Sample 2 with sodium silicate demonstrates a maximum of micropolymer formation in the highest % BPB Extraction. The results are set forth on TABLE X.

TABLE X

| | AEM | Na₄SiO₄ | TEOS | | Shingle | Decking | OSB |
|---|---|---|---|---|---|---|---|
| Application | Actives | Actives | Actives | Na₂C₂O₄ | % BPB | % BPB | % BPB |
| Technology | mg/inch² | mg/inch² | mg/inch² | Conc. | Ext | Ext | Ext |
| AEM | 1.25 | 0 | 0 | 0 | 11 | 19 | 41 |
| Sample 1 | 1.25 | 0 | 0 | 0.1 M | 4 | 22 | 53 |
| Sample 2 | 1.25 | 1.875 | 0 | 0 | 19 | 30 | 62 |
| Sample 2 | 1.25 | 0 | 7.825 | 0 | 55 | 35 | 38 |
| Sample 1 + 2 | 1.25 | 0 | 7.825 | 0.1 M | 10 | 19 | 25 |
| Control | 0 | 0 | 0 | 0 | 0 | 0 | 0 |

1. A method of treating a solid substrate, the method comprising:
(I) providing a solid substrate;
(II) spraying the solid substrate with an aqueous solution of at least one material capable of reacting at or near the solid substrate surface selected from a group consisting of (i) reactive silanes, (ii) reactive siloxanes, (iii) hydrolysis products of (i), (iv) hydrolysis products of (ii), and (v), combinations of any of (i), (ii), (iii), and (iv), and essentially, immediately thereafter,
(III) spraying the solid substrate from (II) with a silicon-containing material capable of reacting at or near the solid substrate surface selected from the group consisting of:
a. materials containing multi-silanol groups,
b. siliconates,
c. silicates, and,
d. any combinations of a., b., and c.

2. A method of treating a solid substrate, the method comprising:
(I) providing a solid substrate;
(II) immersing the solid substrate in an aqueous solution of a at least one material capable of reacting at or near the solid substrate surface selected from a group consisting of (i) reactive silanes, (ii) reactive siloxanes, (iii) hydrolysis products of (i), (iv) hydrolysis products of (ii), and (v), combinations of any of (i), (ii), (iii), and (iv), and essentially, immediately thereafter,
(III) dipping the solid substrate from (II) in a silicon-containing material capable of reacting at or near the solid substrate surface selected from the group consisting of:
a. materials containing multi-silanol groups,
e. siliconates,
f silicates, and,
g. any combinations of a., b., and c.

3. A method of treating a solid substrate, the method comprising:
(I) providing a solid substrate;
(II) spraying the solid substrate with an aqueous solution of at least one material capable of reacting at or near the solid substrate surface selected from a group consisting of (i) reactive silanes, (ii) reactive siloxanes, (iii) hydrolysis products of (i), (iv) hydrolysis products of (ii), and (v), combinations of any of (i), (ii), (iii), and (iv), while essentially simultaneously
(III) spraying the solid substrate from (II) with a silicon-containing material capable of reacting at or near the solid substrate surface selected from the group consisting of:
a. materials containing multi-silanol groups,
b. siliconates,
c. silicates, and,
d. any combinations of a., b., and c.

4. A method as claimed in claim 1 wherein the aqueous solution in (II) also contains a material having a dianion.

5. A method as claimed in claim 2 wherein the aqueous solution in (II) also contains a material having a dianion.

6. A method as claimed in claim 3 wherein the aqueous solution in (II) also contains a material having a dianion.

7. (canceled)

8. (canceled)

9. A method as claimed in claim 3 wherein there is in addition, a catalyst present for the reaction of (III).

10. The method as claimed in claim 1 wherein the material in (II) is a silane.

11. The method as claimed in claim 10 wherein the silane is an organofunctional silane.

12. The method as claimed in claim 2 wherein the material in (II) is a silane.

13. The method as claimed in claim 12 wherein the silane is an organofunctional silane.

14. The method as claimed in claim 3 wherein the material in (II) is a silane.

15. The method as claimed in claim 14 wherein the silane is an organofunctional silane.

16. The method as claimed in claim 1 wherein the material in (II) is an alkoxy functional silane.

17. The method as claimed in claim 16 wherein the silane is an aminoorganofunctional silane.

18. The method as claimed in claim 17 wherein the aminoorganofunctional silane has the general formula:
(RO)ₙSi{(CₓH₂ₓ)N⁺(R²)_{b}(R³)_{3-b}X⁻}₄₋ₙ,
wherein n has a value of 1, 2, or 3; ₓ has a value of 1 to 20; R is an alkyl group having 1 to 6 carbon atoms; each R² is hydrogen or an alkyl group selected from the group consisting of 1 to 6 carbon atoms, X is a halogen, each R³ is hydrogen or an alkyl group selected from the group consisting of 1 to twenty carbon atoms and b has a value of 0, 1, 2, or 3.

19. The method as claimed in claim 18 wherein R is a methyl radical, ₙ has a value of 3, ₓ has a value of 3, each R² is a methyl group.

20. The method as claimed in claim 1 wherein the solid substrate is selected from the group consisting of:

| | | | |
|---|---|---|---|
| a cotton, | b. polyester, | c. nylon, | d. rayon, |
| e. rubber, | f. fibers, | g. acrylic, | h. foams, |
| i. polypropylene, | j. polyethylene, | k. mineral, | l. polyurethane, |
| m. paper, | n. glass, | o. silica, | p. wood, |
| | |
|---|---|
| q. concrete, | r. other solid polymers, s. other hard surfaces, and |
| t. building products. | |

21. The method as claimed in claim 16 wherein the alkoxysilane is trimethoxysilane.

22. The method as claimed in claim 2 wherein the material in (II) is an alkoxy functional silane.

23. The method as claimed in claim 22 wherein the silane is an aminoorganofunctional silane.

24. The method as claimed in claim 23 wherein the aminoorganofunctional silane has the general formula:
(RO)ₙSi{(CₓH₂ₓ)N⁺(R²)_{b}(R³)_{3-b}X⁻}₄₋ₙ,
wherein ₙ has a value of 1, 2, or 3; ₓ has a value of 1 to 20; R is an alkyl group having 1 to 6 carbon atoms; each R² is hydrogen or an alkyl group selected from the group consisting of 1 to 6 carbon atoms, X is a halogen, each R³ is hydrogen or an alkyl group selected from the group consisting of 1 to twenty carbon atoms and b has a value of 0, 1, 2, or 3.

25. The method as claimed in claim 24 wherein R is a methyl radical, ₙ has a value of 3, ₓ has a value of 3, each R² is a methyl group.

26. The method as claimed in claim 2 wherein the solid substrate is selected from the group consisting of:

| | | | |
|---|---|---|---|
| a cotton, | b. polyester, | c. nylon, | d. rayon, |
| e. rubber, | f. fibers, | g. acrylic, | h. foams, |
| i. polypropylene, | j. polyethylene, | k. mineral, | l. polyurethane, |
| m. paper, | n. glass, | o. silica, | p. wood, |
| | |
|---|---|
| q. concrete, | r. other solid polymers, s. other hard surfaces, and |
| t. building products. | |

27. The method as claimed in claim 22 wherein the alkoxysilane is trimethoxysilane.

28. The method as claimed in claim 3 wherein the material in (II) is an alkoxy functional silane.

29. The method as claimed in claim 28 wherein the silane is an aminoorganofunctional silane.

30. The method as claimed in claim 29 wherein the aminoorganofunctional silane has the general formula:
(RO)ₙSi{(CₓH₂ₓ)N⁺(R²)_{b}(R³)_{3-b}X⁻}₄₋ₙ,
wherein ₙ has a value of 1, 2, or 3; ₓ has a value of 1 to 20; R is an alkyl group having 1 to 6 carbon atoms; each R² is hydrogen or an alkyl group selected from the group consisting of 1 to 6 carbon atoms, X is a halogen, each R³ is hydrogen or an alkyl group selected from the group consisting of 1 to twenty carbon atoms and b has a value of 0, 1, 2, or 3.

31. The method as claimed in claim 30 wherein R is a methyl radical, ₙ has a value of 3, ₓ has a value of 3, each R² is a methyl group.

32. The method as claimed in claim 3 wherein the solid substrate is selected from the group consisting of:

| | | | |
|---|---|---|---|
| a cotton, | b. polyester, | c. nylon, | d. rayon, |
| e. rubber, | f. fibers, | g. acrylic, | h. foams, |
| i. polypropylene, | j. polyethylene, | k. mineral, | l. polyurethane, |
| m. paper, | n. glass, | o. silica, | p. wood, |
| | |
|---|---|
| q. concrete, | r. other solid polymers, s. other hard surfaces, and |
| t. building products. | |

33. The method as claimed in claim 28 wherein the alkoxysilane is trimethoxysilane.

34. The method as claimed in claim 1 wherein the material in (II) is an oligomer siloxane.

35. The method as claimed in claim 1 wherein the material in (II) is a polymeric siloxane.

36. The method as claimed in claim 1 wherein the material in (II) is a disilane.

37. The method as claimed in claim 1 wherein the material in (II) contains an —Si(C)_{y}Si—linkage.

38. The method as claimed in claim 37 wherein y has a value of from 1 to 12.

39. The method as claimed in claim 1 wherein the material in (II) is a silicone/organic copolymer.

40. A solid substrate when treated by the method of claim 1.

41. The method as claimed in claim 2 wherein the material in (II) is an oligomer siloxane.

42. The method as claimed in claim 2 wherein the material in (II) is a polymeric siloxane.

43. The method as claimed in claim 2 wherein the material in (II) is a disilane.

44. The method as claimed in claim 2 wherein the material in (II) contains an —Si(C)_{y}Si—linkage.

45. The method as claimed in claim 44 wherein y has a value of from 1 to 12.

46. The method as claimed in claim 2 wherein the material in (II) is a silicone/organic copolymer.

47. A solid substrate when treated by the method of claim 2.

48. The method as claimed in claim 3 wherein the material in (II) is an oligomeric siloxane.

49. The method as claimed in claim 3 wherein the material in (I) is a polymeric siloxane.

50. The method as claimed in claim 3 wherein the material in (II) is a disilane.

51. The method as claimed in claim 3 wherein the material in (II) contains an —Si(C)_{y}Si—linkage.

52. The method as claimed in claim 51 wherein y has a value of from 1 to 12.

53. The method as claimed in claim 3 wherein the material in (II) is a silicone/organic copolymer.

54. A solid substrate when treated by the method of claim 3.
